(19) United States
(12) Patent Application Publication
(10) Pub. No.: US 2010/0188579 A1
(43) Pub. Date: Jul. 29, 2010

(54) System and Method to Control and Present a Picture-In-Picture (PIP) Window Based on Movement Data

(75) Inventor: Lee G. Friedman, Alpharetta, GA (US)

Correspondence Address: AT & T LEGAL DEPARTMENT - Toler;ATTN: PATENT DOCKETING, ROOM 2A-207, ONE AT & T WAY, BEDMINISTER, NJ, 07921, US

(73) Assignee: AT&T INTELLECTUAL PROPERTY I, L.P., Reno, NV (US)

(21) Appl. No.: 12/361,649

(22) Filed: Jan. 29, 2009

(51) Int. Cl. H04N 5/45

(52) U.S. Cl. 348/565; 348/E05.112

(57) ABSTRACT

A method includes receiving selection data from a remote control device to select a portion of a video image displayed at a display device. The method includes creating a dynamic picture-in-picture (PIP) window having a size smaller than the video image. The method includes sending the selected portion of the video image to the display device for display in the dynamic PIP window at the display device. The dynamic PIP window overlays a portion of the video image. The method includes receiving movement data indicating a movement of the remote control device with reference to the display device. The method includes modifying the dynamic PIP window based on the movement data.

### FIELD OF THE DISCLOSURE

The present disclosure is generally related to control and present a picture-in-picture (PIP) window based on movement data.

### BACKGROUND

During a media broadcast, multiple cameras may be used to provide different views of the broadcast. For example, during a sporting event, one view may include the entire field while another view may include an individual player. Typically, a producer of the media broadcast selects which view is broadcast and, at any given time during the broadcast, the viewer sees only the view chosen by the producer.

With the advent of interactive programming, a media broadcast may include multiple views that are user selectable. For example, a broadcast of a sporting event may include multiple views and may allow a user to select from among the multiple views. However, many media broadcasts do not offer user selectable views. In addition, when a media broadcast offers user selectable views, the user is restricted to selecting from among the views that are broadcast.

### BRIEF DESCRIPTION OF THE DRAWINGS

FIG. 1 is a block diagram of a first particular embodiment of a system to modify a picture-in-picture (PIP) window;

FIG. 2 is a block diagram of a second particular embodiment of a system to modify a PIP window;

FIG. 3 is a block diagram of a first particular embodiment of a PIP window;

FIG. 4 is a block diagram of a second particular embodiment of a PIP window;

FIG. 5 is a block diagram of a third particular embodiment of a PIP window;

FIG. 6 is a block diagram of a third particular embodiment of a system to modify a PIP window;

FIG. 7 is a flow diagram of a first particular embodiment of method of modifying a PIP window;

FIG. 8 is a flow diagram of a second particular embodiment of method of modifying a PIP window; and

FIG. 9 is a block diagram of an illustrative embodiment of a general computer system.

### DETAILED DESCRIPTION

In a particular embodiment, a method includes receiving selection data from a remote control device to select a portion of a video image displayed at a display device. The method includes creating a dynamic picture-in-picture (PIP) window having a size smaller than the video image. The method includes sending the selected portion of the video image to the display device for display in the dynamic PIP window at the display device. The dynamic PIP window overlays a portion of the video image. The method includes receiving movement data indicating a movement of the remote control device with reference to the display device. The method includes modifying the dynamic PIP window based on the movement data.

In another particular embodiment, a set-top box device includes an input interface to receive a video signal from a media server and to receive movement data from a remote control device. The set-top box device includes a display module to identify a selected portion of a display at the display device based on selection data received from a remote control device. The set-top box device also includes an output interface to send a display signal based on the video signal to a display device coupled to the set-top box device. The output interface sends a portion of the video signal corresponding to the selected portion of the display to the display device in a PIP window substantially concurrently with sending the display signal to the display device and modifies the PIP window based on the movement data.

In another particular embodiment, a computer-readable storage medium includes operational instructions, that when executed by a processor, cause the processor to receive selection data from a remote control device to select a portion of a video image at a display device. The computer-readable storage medium includes operational instructions, that when executed by the processor, cause the processor to send the selected portion of the video image to the display device for presentation in a PIP window at the display device. The computer-readable storage medium also includes operational instructions, that when executed by the processor, cause the processor to receive mode selection data from the remote control device and to receive movement data indicating a movement of the remote control device. The computer-readable storage medium also includes operational instructions, that when executed by the processor, cause the processor to modify presentation of the PIP window based on the mode selection data and the movement data.

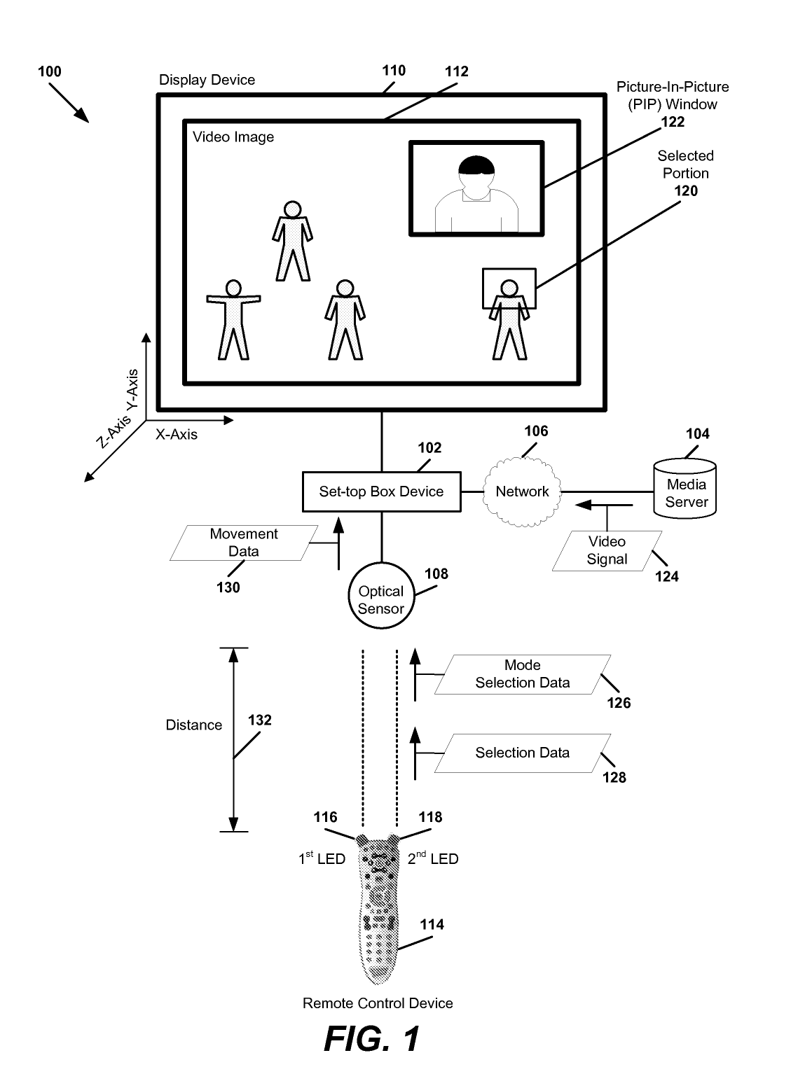

Referring to FIG. 1, a block diagram of a first particular embodiment of a system to modify a picture-in-picture (PIP) window is depicted and generally designated 100. The system 100 includes a set-top box device 102 coupled to a media server 104 via a network 106. An optical sensor 108 and a display device 110 are coupled to the set-top box device 102.

The set-top box device 102 is operable to receive a video signal 124 from the media server 104 via the network 106 and to output a video image 112 at the display device 110 based on the received video signal 124. The set-top box device 102 is further operable to receive selection data 128 from a remote control device 114 and to select a portion of the video image 112. For example, a user may move the remote control device 114 along the x-axis, y-axis, and z-axis to select a portion of the video image 112. To illustrate, the user may move the remote control device 114 left, down, right, and up to select a portion of the video image 112. The set-top box device 112 is further operable to create a PIP window 122 and to send a selected portion 120 to the display device 110 for display in the PIP window 122. The PIP window 122 is also referred to as a dynamic PIP window because the PIP window 122 maybe dynamically created and modified in real-time. The set-top box device 102 is further operable to receive movement data 130 from the optical sensor 108 based on movement of the remote control device 114 and to modify the PIP window 122 based on the movement data 130.

The remote control device 114 includes a first light emitting diode (LED) 116 and a second LED 118. The LEDs 116 and 118 are operable to transmit various types of data that the optical sensor 108 is capable of receiving. For example, the remote control device 114 may send mode selection data 126 and the selection data 128 to the set-top box device 102.

The optical sensor 108 is operable to receive various types of data from the LEDs 116 and 118. In a particular embodiment, the optical sensor 108 is integrated into the set-top box device 102. In another particular embodiment, the optical sensor 108 is coupled to a port (not shown) of the set-top box device 102. For example, the optical sensor 108 may be coupled to a universal serial bus (USB) port or Institute of Electrical and Electronics Engineers (IEEE) 1394 port of the set-top box device 102. The optical sensor 108 is further operable to detect movement of the remote control device 114 and to generate the movement data 130 based on the detected movement. The movement of the remote control device 114 may include movement relative to the optical sensor 108, including up, down, left, right, closer, farther, or any combination thereof. For example, the LEDs 116 and 118 may be a predetermined distance apart, and the optical sensor 108 may be adapted to detect light from the LEDs 116 and 118 and to determine how far the remote control device 114 is located from the optical sensor 108 based on the detected light. The optical sensor 108 may be adapted to determine motion of the remote control device 114 along an X-axis, a Y-axis and a Z-axis with reference to the display device 110, with reference to the set-top box device 102, or with reference to the optical sensor 108. The Z-axis may be approximately perpendicular to a plane of the display device 110. The X-axis and the Y-axis are approximately parallel to the plane of the display device 110. For example, the X-axis may be horizontal (e.g., right and left) with respect to the display device 110 and the Y-axis may be vertical (e.g., up and down) with respect to the display device 110. Components of motion of the remote control device 114 along the X-axis and the Y-axis may be referred to as lateral motion.

In a particular embodiment, the optical sensor 108 may measure a distance 132 of the remote control device 114 from the optical sensor 108 and generate the movement data 130 when the optical sensor 108 detects a change of the distance 132. In a particular embodiment, the optical sensor 108 is operable to determine a distance of the remote control device 114 from the set-top box device 102 based on the distance 132. In another particular embodiment, the optical sensor 108 is operable to determine a distance of the remote control device 114 from the display device 110 based on the distance 132.

In operation, the set-top box device 102 receives the selection data 128 from the remote control device 114. The selection data 128 selects a portion of the video image 112 displayed at the display device 110. The set-top box device 102 creates a PIP window 122 at the display device 110. In a particular embodiment, the PIP window 122 has a size smaller than the video image 112. The set-top box device 102 sends the selected portion 120 of the video image 112 to the display device 110 for display in the PIP window 122 at the display device 110. The PIP window 122 overlays at least a portion of the video image 112.

The set-top box device 102 receives movement data 130 from the optical sensor 108 indicating a movement of the remote control device 114 with reference to the display device 110. The set-top box device 102 modifies the PIP window 122 based on the movement data 130. Modifying the PIP window 122 may include zooming in the selected portion 120 of the video image 112 when the movement data 130 indicates that the remote control device 114 has moved closer to the display device 110 (e.g. the distance 132 has decreased). Modifying the PIP window 122 may include zooming out the selected portion 120 of the video image 112 when the movement data 130 indicates that the remote control device 114 has moved away from the display device 110 (e.g. the distance 132 has increased).

The set-top box device 102 may use the movement data 130 to modify the PIP window 122 in different ways. For example, the set-top box device 102 may use the movement data 130 to zoom in or zoom out the selected portion 120, change the selected portion 120 (e.g. change the selected portion 120 to a different portion of the video image 112), change a location of the PIP window 122, or change a size of the PIP window 122 (e.g. increase or decrease the size of the PIP window). In a particular embodiment, the set-top box device 102 receives mode selection data 126 prior to receiving the selection data 128 and modifies the PIP window 122 in a particular way based on the movement data 130. The mode selection data 126 instructs the set-top box device 102 how to modify the PIP window 122 based on the movement data 130. For example, when the mode selection data 126 selects a first mode, the set-top box device 102 zooms in or zooms out the contents of the PIP window 122 based on the movement data 130. When the mode selection data 126 selects a second mode, the set-top box device 102 alters a location of the selected portion 120 of the video image 112 based on the movement data 130. When the mode selection data 126 selects a third mode, the set-top box device 102 alters a size of the PIP window 122 based on the movement data 130. When the mode selection data 126 selects a fourth mode, the set-top box device 102 alters a location of the PIP window 122 at the display device 110 based on the movement data 130.

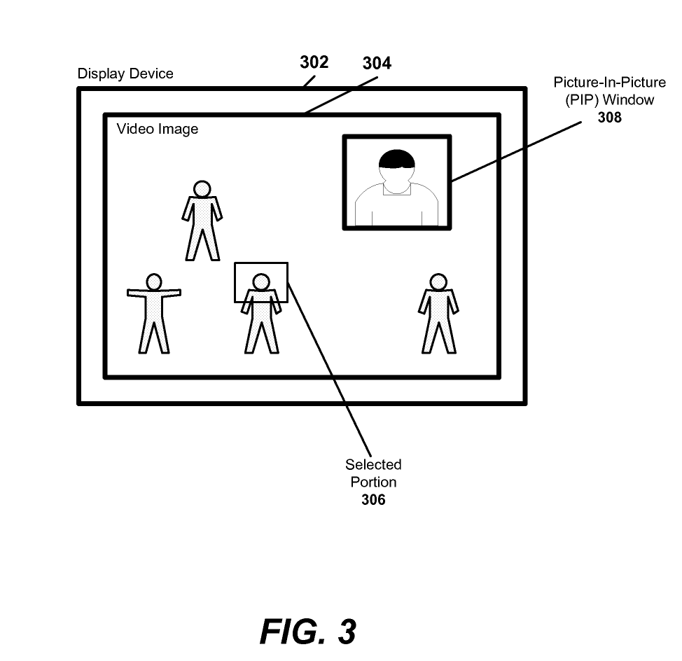

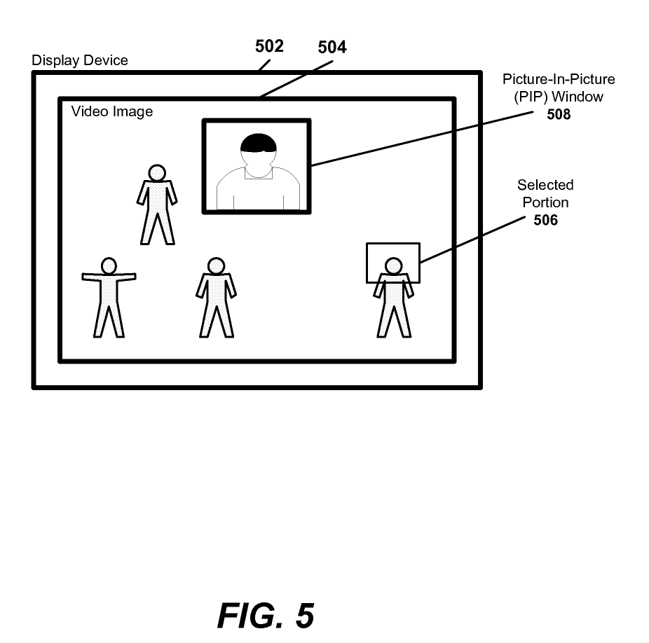

By receiving the selection data 128 from the remote control device 114 and by receiving the movement data 130 from the optical sensor 108, the set-top box device 102 can modify the PIP window 122 in different ways. For example, the selected portion 120 may be zoomed in or zoomed out within the PIP window 122, or the PIP window size may be increased or decreased. The location of the selected portion 120 may be modified by moving the selected portion 120 to select a different portion of the video image 112, as is discussed in more detail in FIG. 3. The location of the PIP window 122 may be modified by moving the PIP window 122 to a different location at the display device 110, as is discussed in more detail in FIG. 5. In this way, a user of the set-top box device 102 may view different views of the video image 112 that the user creates based on moving the remote control device 114. For example, during a baseball game, when the video image 112 displays the entire field, a user may use the PIP window 122 to zoom in on the selected portion 120 showing a particular player. As the game progresses, the user may use the remote control device 114 to change the selected portion 120 to display different players that the user wishes to view.

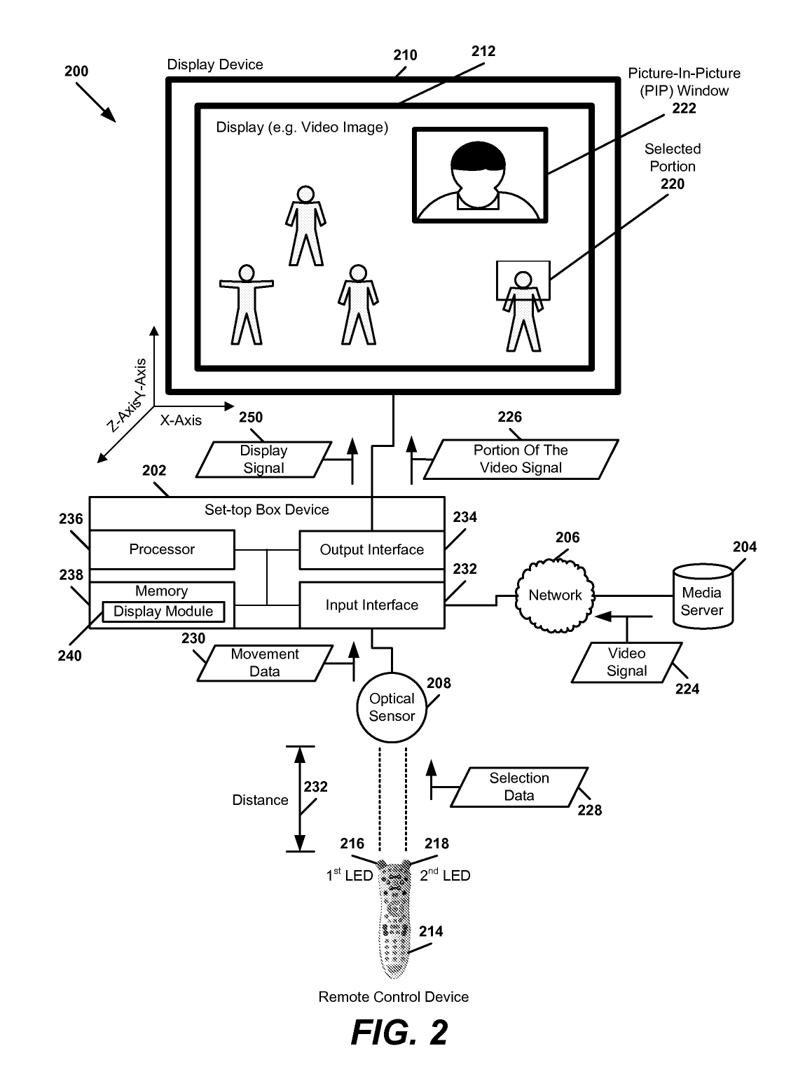

Referring to FIG. 2, a block diagram of a second particular embodiment of a system to modify a picture-in-picture (PIP) window is depicted and generally designated 200. The system 200 includes a set-top box device 202 coupled to a media server 204 via a network 206. An optical sensor 208 and a display device 210 are coupled to the set-top box device 202.

The set-top box device 202 includes an input interface 232, an output interface 234, a processor 236, and a memory 238. The memory 238 includes a display module 240. The set-top box device 202 is operable to receive a video signal 224 at the input interface 232 from the media server 204 via the network 206. The display module 240 is operable to output a display signal 250 at the output interface 234. The display signal 250 is used to generate a display 212 (e.g. a video image) at the display device 210. The display module 240 is further operable to receive selection data 228 at the input interface 232 from a remote control device 214 and to select a portion of the video image 212 based on the selection data 228. The set-top box device 202 is further operable to create a PIP window 222 at the display device 210 and to send a portion of the video signal 226 to the display device 210 for display in the PIP window 222. The portion of the video signal 226 corresponds to the selected portion 220 of the display 212. The set-top box device 202 is further operable to receive movement data 230 from the optical sensor 208 based on movement of the remote control device 214 and to modify the PIP window 222 based on the movement data 230. In a particular embodiment, the display 212 has a high definition resolution of at least 720 lines of resolution and the PIP window 222 has a standard definition resolution of less than 720 lines of resolution.

The remote control device 214 includes a first light emitting diode (LED) 216 and a second LED 218 that are a pre-determined distance apart to enable the optical sensor 208 to measure a distance of the remote control device 214 from the optical sensor 208. The LEDs 216 and 218 are operable to transmit various types of data that the optical sensor 208 is capable of receiving. For example, the remote control device 214 may send the selection data 228 to the set-top box device 202 by transmitting data from the LEDs 216 and 218 to the optical sensor 208.

The optical sensor 208 is coupled to the input interface 232 of the set-top box device 202. The optical sensor 208 is operable to detect movement of the remote control device 214 and to generate movement data 230 based on the movement of the remote control device 214. The optical sensor 208 is further operable to send the movement data 230 to the input interface 232 of the set-top box device 202. The movement of the remote control device 214 may include movement relative to the optical sensor 208, including up, down, left, right, closer, farther, or any combination thereof. For example, the LEDs 216 and 218 may be a predetermined distance apart, and the optical sensor 208 may be adapted to detect light from the LEDs 216 and 218 and to determine how far the remote control device 214 is located from the optical sensor 208 based on the detected light. The optical sensor 208 may be adapted to determine motion of the remote control device 214 along an X-axis, a Y-axis and a Z-axis with reference to the display device 210, with reference to the set-top box device 202, or with reference to the optical sensor 208. The Z-axis may be approximately perpendicular to a plane of the display device 210. The X-axis and the Y-axis are approximately parallel to the plane of the display device 210. For example, the X-axis may be horizontal (e.g., right and left) with respect to the display device 210 and the Y-axis may be vertical (e.g., up and down) with respect to the display device 210. Components of motion of the remote control device 214 along the X-axis and the Y-axis may be referred to as lateral motion.

The optical sensor 208 is further operable to measure a distance 232 of the LEDs 216 and 218 from the set-top box device and to generate the movement data 230 when the distance 232 changes. For example, the optical sensor 208 may determine a distance between the set-top box device 202 and the remote control device 214 based on measuring the distance 232 between the LEDs 216 and 218 and the optical sensor 208. The optical sensor 208 may detect movement of the remote control device 214 by detecting a change in the distance 232 of the remote control device 214 from the optical sensor 208. The optical sensor 208 may detect movement of the remote control device 214 by measuring a left motion, a right motion, an up motion, and a down motion of the remote control device 214 with reference to the optical sensor 208.

In operation, the display module 240 receives selection data 228 from the remote control device 214 and identifies the selected portion 220 of the display 212 at the display device 210 based on the selection data 228. The output interface 234 sends the portion of the video signal 226 corresponding to the selected portion 220 of the display 212 for display in a picture-in-picture (PIP) window 222 substantially concurrently with sending the display signal 250 to the display device 210. The display module 240 modifies the PIP window 222 based on the movement data 230 received from the optical sensor 208. The display module 240 zooms in the selected portion 220 of the display 212 when the movement data 230 indicates that the distance 232 of the remote control device 214 from the optical sensor 208 has decreased. For example, when the distance 232 is less than the distance 132 of FIG. 1, the PIP window 222 of FIG. 2 is zoomed in relative to the PIP window 122 of FIG. 1. The display module 242 zooms out the selected portion 220 of the display 212 when the movement data 230 indicates that the distance 232 of the remote control device 214 from the optical sensor 208 has increased. For example, when the distance 132 of FIG. 1 is greater than the distance 232 of FIG. 2, the PIP window 122 of FIG. 1 is zoomed out relative to the PIP window 222 of FIG. 2.

Thus, the set-top box device 202 can modify the PIP window 222 in different ways based on the selection data 228 and the movement data 230. For example, the selected portion 220 may be zoomed in or zoomed out within the PIP window 222 based on the movement data 230. The PIP window size may be increased or decreased based on the movement data 230. The location of the selected portion 220 may be modified by moving the selected portion 220 to select a different portion of the video image 212 based on the movement data 230, as is discussed in more detail in FIG. 3. The location of the PIP window 222 may be modified by moving the PIP window 222 to a different location at the display device 210 based on the movement data 230, as is discussed in more detail in FIG. 5. In this way, a user of the set-top box device 202 may view user-selected views of the video image 212 without the video signal 224 including those particular views. For example, during a concert broadcast, when the video image 212 displays the entire stage, a user may use the PIP window 222 to zoom in on the selected portion 220 of a particular performer. The user may then change the selected portion 220 during the broadcast to display different performers.

Referring to FIG. 3, a block diagram of a first particular embodiment of a picture-in-picture (PIP) window is depicted. FIG. 3 includes a display device 302 having a video image 304, a selected portion 306, and a PIP window 308. In FIG. 3, the selected portion 306 is displayed in the PIP window 308. The selected portion 306 may be selected based on the selection data 128 of FIG. 1 or the selection data 228 of FIG. 2.

FIG. 3 illustrates how the PIP window 308 may be modified by changing the selected portion 306. For example, the remote control device 114 of FIG. 1 may be used to modify the PIP window 122 to the PIP window 308 by changing a user selection from the selected portion 120 to the selected portion 306. To illustrate, the remote control device 114 may be moved laterally to change the user selection. Thus, a user may move a remote control device, such as the remote control device 114, to select different portions of the video image 304. For example, when viewing a sporting event, the user may select a first particular player and then modify the selected portion 306 to select a different player.

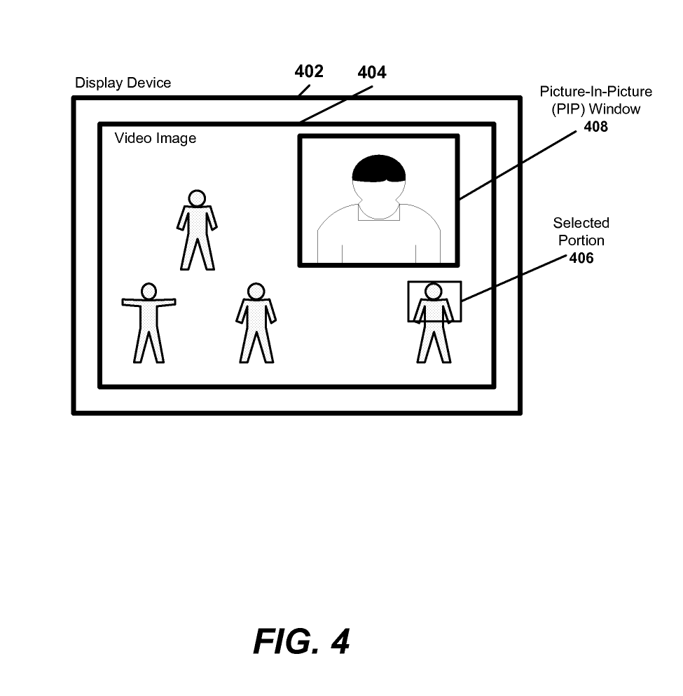

Referring to FIG. 4, a block diagram of a second particular embodiment of a picture-in-picture (PIP) window is depicted. FIG. 4 includes a display device 402 having a video image 404, a selected portion 406 and a PIP window 408. FIG. 4 illustrates how the size of the PIP window 408 may be modified. In FIG. 4, the PIP window 408 is larger than the PIP window 122 of FIG. 1 and the PIP window 222 of FIG. 2.

For example, the PIP window 408 may increase in size based on the movement data 130. To illustrate, by moving the remote control device 114 of FIG. 1 away from the optical sensor 108 to increase the distance 132, the movement data 130 may be used to increase a size of the PIP window 122 to the size of the PIP window 408. By moving the remote control device 114 of FIG. 1 closer to the optical sensor 108 to decrease the distance 132, the movement data 130 may be used to decrease the size of the PIP window 408 to the size of the PIP window 122 of FIG. 1. Thus, a user may select a size of the PIP window 408 that is appropriate relative to the size of the video image 404.

Referring to FIG. 5, a block diagram of a third particular embodiment of a picture-in-picture (PIP) window is depicted. FIG. 5 includes a display device 502, a video image 504, a selected portion 506, and a picture-in-picture (PIP) window 508. FIG. 5 illustrates how the movement data 130 of FIG. 1 or the movement data 230 of FIG. 2 may be used to change a location of the PIP window 508 at the display device 502.

In FIG. 5, a location of the PIP window 508 at the display device 502 has changed compared to the PIP window 122 of FIG. 1 and the PIP window 222 of FIG. 2. For example, lateral movement of the remote control device 114 of FIG. 1 may be used to move a location of the PIP window 122 to a location of the PIP window 508. Thus, a user may use movement of a remote control device, such as the remote control device 114 of FIG. 1 or the remote control device 214 of FIG. 2, to change a location of the PIP window 508 to enable the user to view the video image 504 without the PIP window 508 overlaying a portion of the video image 504 that the user wishes to view.

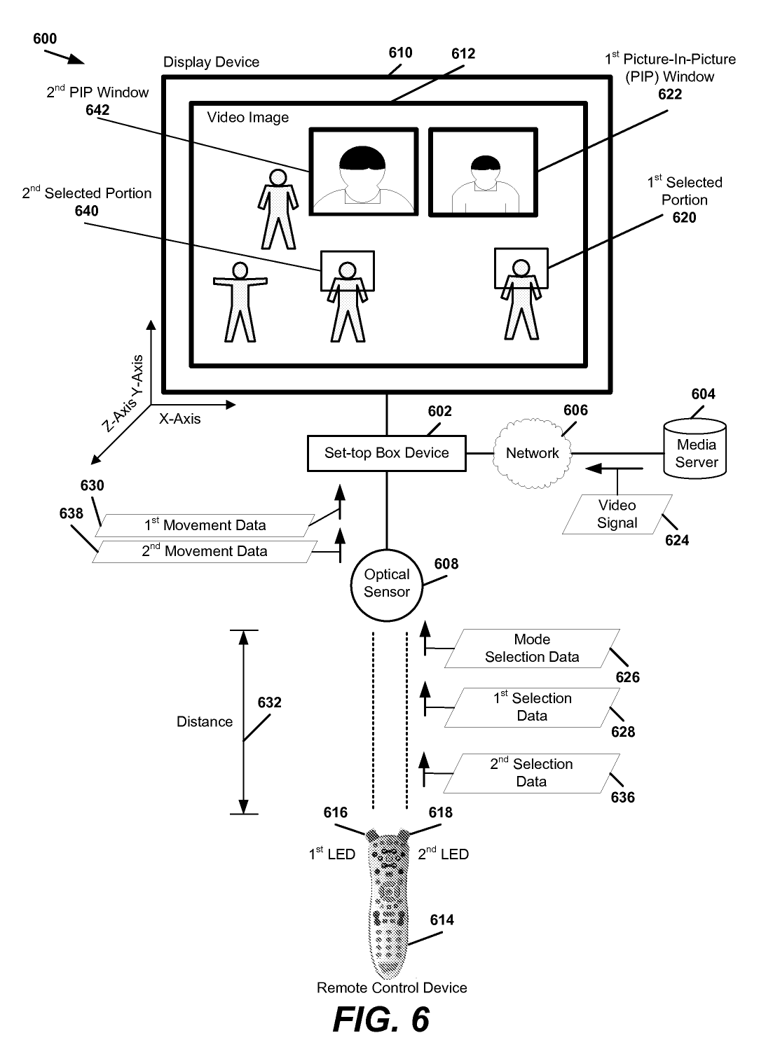

Referring to FIG. 6, a block diagram of a third particular embodiment of a system to modify a PIP window is depicted and generally designated 600. The system 600 includes a set-top box device 602 coupled to a media server 604 via a network 606. An optical sensor 608 and a display device 610 are coupled to the set-top box device 602.

The set-top box device 602 is operable to receive a video signal 624 from the media server 604 via the network 606 and to output a video image 612 at the display device 610 based on the video signal 624. The set-top box device 602 is further operable to receive first selection data 628 from a remote control device 614 to select the first selected portion 620 of the video image 612, to create a first PIP window 622, and to send the first selected portion 620 to the display device 610 for display in the first PIP window 622. The set-top box device 602 is further operable to receive first movement data 630 from the optical sensor 608 and to modify the first PIP window 622 based on the first movement data 630 based on movement of a remote control device 614. The set-top box device 602 is further operable to receive second selection data 636 to select the second portion 640, to create a second PIP window 642, and to send the second selected portion 640 to the display device 610 for display in the second PIP window 642. The first PIP window 622 and the second PIP window 642 may be referred to as dynamic PIP windows because the first PIP window 622 and the second PIP window 642 may be dynamically created and modified in real-time. The set-top box device 602 is further operable to receive second movement data 638 from the optical sensor 608 based on movement of the remote control device 614 and to modify the second PIP window 642 based on the second movement data 638. In a particular embodiment, mode selection data 626 is sent to the set-top box device 602 from the remote control device 614 to select from among the first PIP window 622 and the second PIP window 642. The mode selection data 626 may also be used to determine the type of modification that is performed to the first PIP window 622 or the second PIP window 642.

The remote control device 614 includes a first light emitting diode (LED) 616 and a second LED 618. The LEDs 616 and 618 are operable to transmit various types of data that the optical sensor 608 is capable of receiving. For example, the remote control device 614 may send the mode selection data 626, the first selection data 628, and the second selection data 636 to the set-top box device 602 by transmitting data from the LEDs 616 and 618 to the optical sensor 608.

The optical sensor 608 is operable to receive various types of data from the LEDs 616 and 618. The optical sensor 608 is further operable to detect movement of the remote control device 614 and to generate the first movement data 630 or the second movement data 638 based on the movement. The movement of the remote control device 614 may include movement relative to the optical sensor 608, including up, down, left, right, closer, farther, or any combination thereof. The optical sensor 608 may be adapted to determine motion of the remote control device 614 along an X-axis, a Y-axis and a Z-axis with reference to the display device 610, with reference to the set-top box device 602, or with reference to the optical sensor 608. The Z-axis may be approximately perpendicular to a plane of the display device 610. The X-axis and the Y-axis are approximately parallel to the plane of the display device 610. For example, the X-axis may be horizontal (e.g., right and left) with respect to the display device 610 and the Y-axis may be vertical (e.g., up and down) with respect to the display device 610. Components of motion of the remote control device 614 along the X-axis and the Y-axis may be referred to as lateral motion.

In operation, the set-top box device 602 receives the first selection data 628 from the remote control device 614 to select a portion of the video image 612 at the display device 610. The set-top box device 602 creates a first PIP window 622 and sends the first selected portion 620 of the video image 612 for display in the first PIP window 622 at the display device 610. The set-top box device 602 receives first movement data 630 indicating a movement of the remote control device with reference to the display device 610 and modifies the first PIP window 622 based on the first movement data 630.

The set-top box device 602 may receive the second selection data 636 from the remote control device 614 to select the second selected portion 640 of the video image 612. The set-top box 602 may create the second PIP window 642 and send the second selected portion 640 of the video image 612 for display in the second PIP window 642 at the display device 610. The set-top box device 602 may modify the second PIP window 642 based on the second movement data 638 received from the optical sensor 608. For example, the second portion 640 of the video image 612 may be zoomed in or zoomed out based on the second movement data 638 when the distance 632 of the remote control device 614 from the optical sensor 608 is increased or decreased. The size the second PIP window 642 may be increased or decreased based on the second movement data 638 when the distance 632 of the remote control device 614 from the optical sensor 608 is increased or decreased. The location of the second PIP window 642 may be modified by the second movement data 638 when the remote control device 614 is moved laterally. The mode selection data 626 may select from one of the PIP windows 622 and 642 and may select the type of modification to perform to the selected PIP window.

By selecting the first selected portion 620 and the second selected portion 640, a user may zoom in on various portions of the video image 612 and display the selected portions 620 and 640 in the first PIP window 622 and the second PIP window 642, respectively. The user may modify the contents of the first PIP window 622 and the second PIP window 642 based on the movement of the remote control device 614 relative to the optical sensor 608. By using the first movement data 630 to modify the first PIP window 622 and the second PIP window 642, a user can display user selected views that are not broadcast and that are of interest to the user.

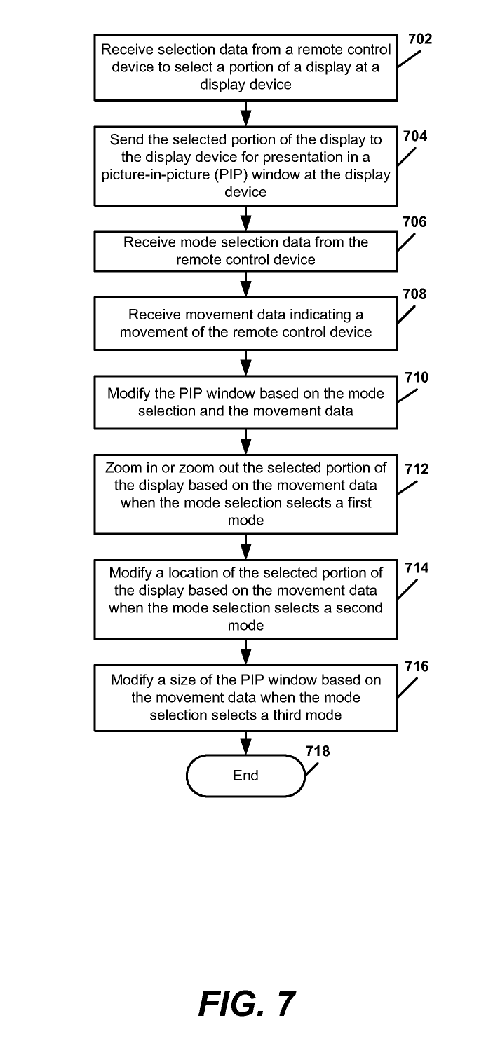

Referring to FIG. 7, a flow diagram of a first particular embodiment of a method of modifying a PIP window is depicted. The method may be performed by a set-top box, such as the set-top box 102 of FIG. 1, the set-top box device 202 of FIG. 2, or the set-top box device 602 of FIG. 6.

Selection data selecting a portion of a display at a display device is received from a remote control device, at 702. Moving to 704, the selected portion of the display is sent to the display device for presentation in a picture-in-picture (PIP) window at the display device. Advancing to 706, mode selection data is received from the remote control device. The mode selection data may determine the type of modification that is made to the PIP window. For example, in a first mode, movement data received from a remote control device may be used to zoom in or zoom out a selected portion of a display. In a second mode, movement data received from a remote control device may be used to modify a location of a selected portion of a display. In a third mode, movement data received from a remote control device may be used to modify a size of a PIP window. In a fourth mode, movement data received from a remote control device may be used to change a location of a PIP window at a display. Continuing to 708, movement data indicating a movement of the remote control device is received.

Moving to 710, the PIP window is modified based on the mode selection data and the movement data. Proceeding to 712, in a particular embodiment, the selected portion of the display is zoomed in or zoomed out based on the movement data when the mode selection data selects a first mode. Continuing to 714, in particular embodiment, a location of the selected portion of the display is altered based on the movement data when the mode selection data selects a second mode. Advancing to 716, a size of the PIP window is modified based on the movement data when the mode selection data selects a third mode. The method ends at 718.

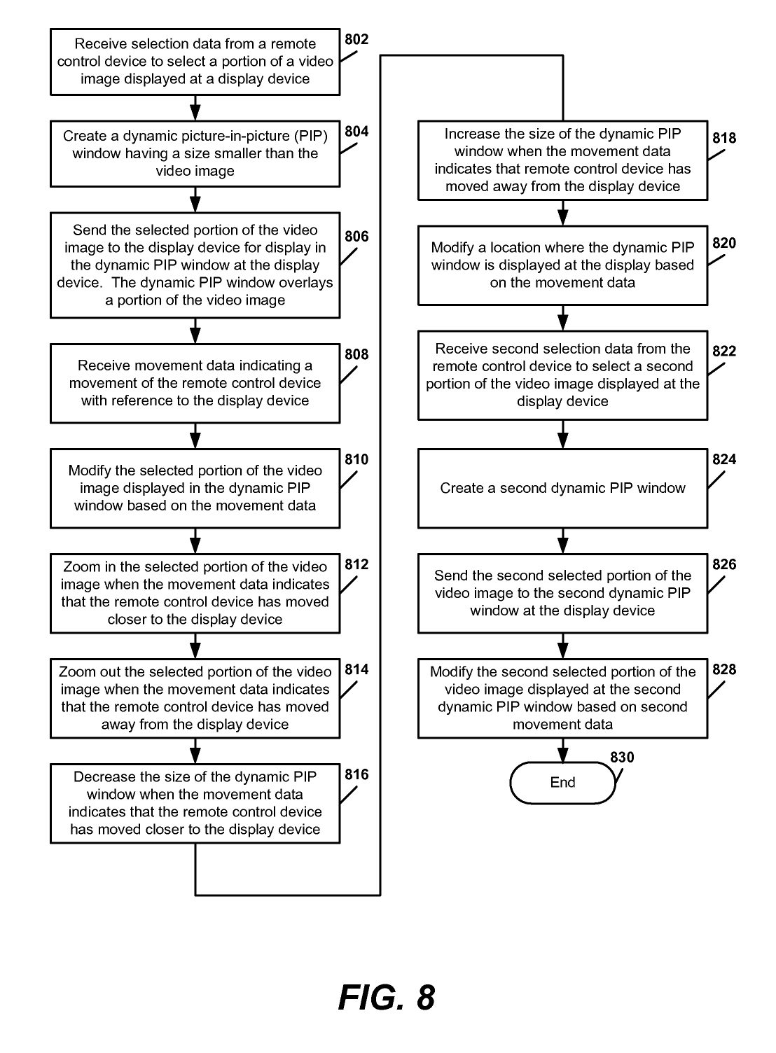

Referring to FIG. 8, a flow diagram of a second particular embodiment of a method of modifying a PIP window is depicted. The method may be performed by the set-top box 102 of FIG. 1, the set-top box 202 of FIG. 2, or the set-top box 602 of FIG. 6.

Selection data to select a portion of a video image displayed at a display device is received from a remote control device, at 802. Moving to 804, a PIP window is created having a size smaller than the video image. Advancing to 806, the selected portion of the video image is sent to the display device for display in the PIP window at the display device. The PIP window overlays a portion of the video image. Continuing to 808, movement data indicating a movement of the remote control device with reference to the display device is received.

Proceeding to 810, the selected portion of the video image displayed at the PIP window is modified based on the movement data. Moving to 812, the selected portion of the video image is zoomed in when the movement data indicates that the remote control device has moved closer to the display device. Proceeding to 814, the selected portion of the video image is zoomed out when the movement data indicates that the remote control device has moved away from the display device.

Proceeding to 816, the size of the PIP window is decreased when the movement data indicates that the remote control device has moved closer to the display device. For example, in FIG. 2, the size of the PIP window 222 is decreased when the movement data 230 indicates that the remote control device 214 has moved closer to the display device 210. Advancing to 818, the size of the PIP window is increased when the movement data indicates that the remote control device has moved away from the display device. Advancing to 820, a location where the PIP window is moved based on the movement data.

Continuing to 822, second selection data is received from the remote control device to select a second portion of the video image. Advancing to 824, a second PIP window is created. For example, in FIG. 6, the set-top box device 602 creates the second PIP window 642 to display the second selected portion 640. Proceeding to 826, the second selected portion of the video image is sent to the second PIP window at the display device. Continuing to 828, the second selected portion of the video image displayed at the second PIP window is modified based on second movement data. The method ends at 830.

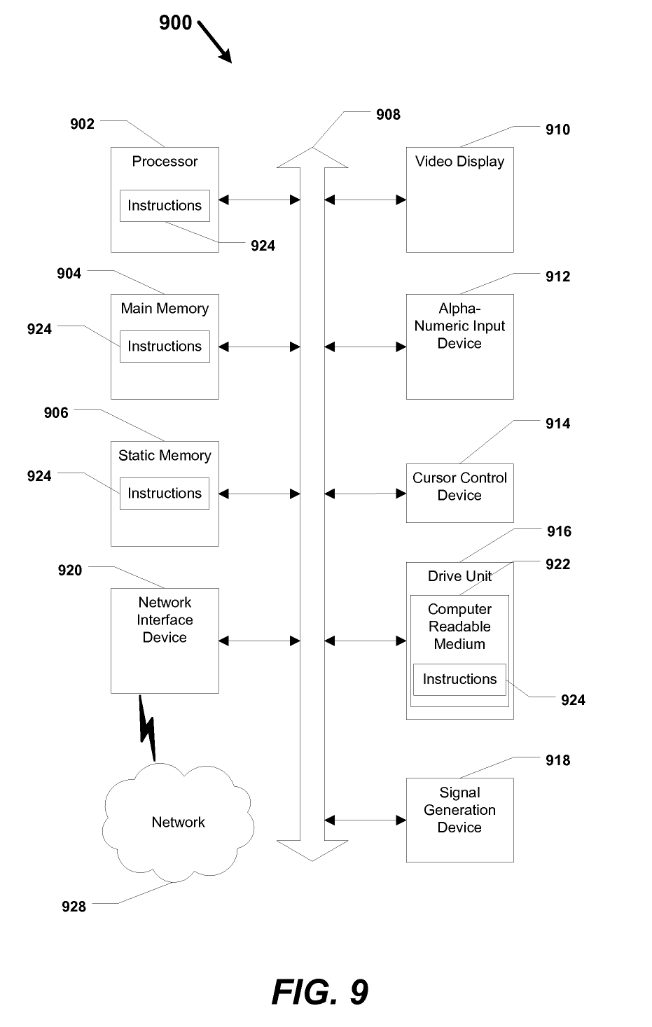

Referring to FIG. 9, an illustrative embodiment of a general computer system is shown and is designated 900. The computer system 900 includes a set of instructions that can be executed to cause the computer system 900 to perform any one or more of the methods or computer based functions disclosed herein. The computer system 900, or any portion thereof, may operate as a standalone device or may be connected, e.g., using a network, to other computer systems or peripheral devices.

In a networked deployment, the computer system may operate in the capacity of a set-top box device or media server, such as the set-top box device 102 or the media server 104 of FIG. 1, the set-top box device 202 or the media server 204 of FIG. 2, and the set-top box device 602 or the media server 604 of FIG. 6. The computer system 900 can also be implemented as or incorporated into various devices, such as a personal computer (PC), a tablet PC, a personal digital assistant (PDA), a mobile device, a palmtop computer, a laptop computer, a desktop computer, a communications device, a web appliance, or any other machine capable of executing a set of instructions (sequential or otherwise) that specify actions to be taken by that machine. In a particular embodiment, the computer system 900 can be implemented using electronic devices that provide voice, video or data communication. Further, while a single computer system 900 is illustrated, the term “system” shall also be taken to include any collection of systems or sub-systems that individually or jointly execute a set, or multiple sets, of instructions to perform one or more computer functions.

As illustrated in FIG. 9, the computer system 900 may include a processor 902, e.g., a central processing unit (CPU), a graphics-processing unit (GPU), or both. Moreover, the computer system 900 can include a main memory 904 and a static memory 906 that can communicate with each other via a bus 908. As shown, the computer system 900 may further include a video display unit 910, such as a liquid crystal display (LCD), an organic light emitting diode (OLED), a flat panel display, a solid-state display, or a projection display. Additionally, the computer system 900 may include an input device 912, such as a keyboard, a remote control device, and a cursor control device 914, such as a mouse or a remote control device. The computer system 900 can also include a disk drive unit 916, a signal generation device 918, such as a speaker or remote control device, and a network interface device 920. The network interface device 920 may be coupled to other devices (not shown) via a network 928.

In a particular embodiment, as depicted in FIG. 9, the disk drive unit 916 may include a computer-readable medium 922 in which one or more sets of instructions 924, e.g. software, can be embedded. Further, the instructions 924 may embody one or more of the methods or logic as described herein. In a particular embodiment, the instructions 924 may reside completely, or at least partially, within the main memory 904, the static memory 906, and/or within the processor 902 during execution by the computer system 900. The main memory 904 and the processor 902 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 924 or receives and executes instructions 924 responsive to a propagated signal, so that a device connected to a network 928 can communicate voice, video or data over the network 928. Further, the instructions 924 may be transmitted or received over the network 928 via the network interface device 920.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, or encoding a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an email or other self-contained information archive or set of archives may be considered equivalent to a tangible storage medium. Accordingly, the disclosure is considered to include any one or more of a computer-readable storage medium and other equivalents and successor media, in which data or instructions may be stored.

It should also be noted that software that implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, MPEG, SMPTE, H.264) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method, comprising:
receiving selection data from a remote control device to select a portion of a video image displayed at a display device;
creating a dynamic picture-in-picture (PIP) window having a size smaller than the video image;
sending the selected portion of the video image to the display device for display in the dynamic PIP window at the display device, the dynamic PIP window overlaying at least a portion of the video image;
receiving movement data indicating a movement of the remote control device with reference to the display device; and
modifying the dynamic PIP window based on the movement data.

2. The method of claim 1, wherein the movement data is received from an optical sensor.

3. The method of claim 1, wherein modifying the dynamic PIP window includes zooming in the selected portion of the video image when the movement data indicates that the remote control device has moved closer to the display device.

4. The method of claim 1, wherein modifying the dynamic PIP window includes zooming out the selected portion of the video image when the movement data indicates that the remote control device has moved away from the display device.

5. The method of claim 1, wherein modifying the dynamic PIP window includes decreasing the size of the dynamic PIP window when the movement data indicates that the remote control device has moved closer to the display device.

6. The method of claim 1, wherein modifying the dynamic PIP window includes increasing the size of the dynamic PIP window when the movement data indicates that remote control device has moved away from the display device.

7. The method of claim 1, wherein modifying the dynamic PIP window includes moving a location where the dynamic PIP window is displayed at the display device based on the movement data.

8. The method of claim 1, further comprising:
receiving second selection data from the remote control device to select a second portion of the video image displayed at the display device;
creating a second dynamic PIP window; and
sending the second selected portion of the video image to the second dynamic PIP window at the display device.

9. The method of claim 8, further comprising modifying the second dynamic PIP window based on second movement data.

10. A set-top box device, comprising:
an input interface to receive a video signal from a media server and to receive movement data from a remote control device;
a display module to identify a selected portion of a display at the display device based on selection data received from the remote control device; and
an output interface to send a display signal based on the video signal to the display device coupled to the set-top box device, to send a portion of the video signal corresponding to the selected portion of the display to the display device in a picture-in-picture (PIP) window substantially concurrently with sending the display signal to the display device, and to modify the PIP window based on the movement data.

11. The set-top box device of claim 10, further comprising an optical sensor coupled to the input interface to detect movement of the remote control device, to generate the movement data based on the movement, and to send the movement data to the input interface.

12. The set-top box device of claim 11, wherein the optical sensor is further operable to measure a distance of a plurality of light emitting diodes (LEDs) of the remote control device from the optical sensor to generate the movement data.

13. The set-top box device of claim 12, wherein at least two of the plurality of LEDs of the remote control device are a predetermined distance apart, and wherein the optical sensor determines a distance between the set-top box device and the remote control device based on a measured distance between the LEDs and the optical sensor.

14. The set-top box device of claim 11, wherein detecting movement of the remote control device comprises detecting a change in a distance of the remote control device from the optical sensor.

15. The set-top box device of claim 11, wherein detecting the movement of the remote control device comprises measuring a left motion and a right motion of the remote control device with reference to the optical sensor.

16. The set-top box device of claim 11, wherein detecting the movement of the remote control device comprises measuring an up motion and a down motion of the remote control device with reference to the optical sensor.

17. The set-top box device of claim 11, wherein the display module is further operable to zoom in the selected portion of the display when the movement data indicates that a distance of the remote control device from the optical sensor has decreased.

18. The set-top box device of claim 11, wherein the display module is further operable to zoom out the selected portion of the display when the movement data indicates that a distance of the remote control device from the optical sensor has increased.

19. The set-top box device of claim 11, wherein the display at the display device has a high definition (HD) resolution and wherein the PIP window has a standard definition (SD) resolution.

20. A computer-readable storage medium comprising operational instructions, that when executed by a processor, cause the processor to:
receive selection data from a remote control device to select a portion of a video image at a display device;
send the selected portion of the video image to the display device for presentation in a picture-in-picture (PIP) window at the display device;
receive mode selection data from the remote control device;
receive movement data indicating a movement of the remote control device; and
modify presentation of the PIP window based on the mode selection data and the movement data.

21. The computer-readable storage medium of claim 20, further comprising operational instructions, that when executed by the processor, cause the processor to zoom in or zoom out the selected portion of the video image based on the movement data when the mode selection data selects a first mode.

22. The computer-readable storage medium of claim 20, further comprising operational instructions, that when executed by the processor, cause the processor to modify a location of the selected portion of the video image based on the movement data when the mode selection data selects a second mode.

23. The computer-readable storage medium of claim 20, further comprising operational instructions, that when executed by the processor, cause the processor to modify a size of the PIP window based on the movement data when the mode selection data selects a third mode.

24. The computer-readable storage medium of claim 20, further comprising operational instructions, that when executed by the processor, cause the processor to modify a location of the PIP window based on the movement data when the mode selection data selects a fourth mode.
